(19) United States
(12) Patent Application Publication
(10) Pub. No.: US 2026/0042053 A1
(43) Pub. Date: Feb. 12, 2026

(54) HUMIDITY ADJUSTING DEVICE CAPABLE OF BEING INSPECTED IN AN OPERATING STATE

(71) Applicant: ACE DRAGON CORP., Hsinchu County (TW)

(72) Inventor: Min-Jen TSAO, Hsinchu County (TW)

(21) Appl. No.: 19/054,312

(22) Filed: Feb. 14, 2025

(30) Foreign Application Priority Data
Aug. 12, 2024 (TW) 113208640

(51) Int. Cl. B01D 53/26; B01D 53/14

(52) U.S. Cl. CPC B01D 53/263; B01D 53/1412; B01D 53/1425; B01D 2257/80; B01D 2258/06

(57) ABSTRACT

A humidity adjusting device capable of being inspected in an operating state is arranged in a humidity adjusting cabinet. The humidity adjusting cabinet includes a storage space and an extra-cabinet space. The humidity adjusting device comprises a shell assembly, a covering plate, a bi-state switching valve assembly, a humidity adjusting module, a humidity sensor and a main circuit board. The shell assembly has humidity adjusting space. The covering plate fitly covers a side of the shell assembly adjacent to extra-cabinet space. The bi-state switching valve assembly, humidity adjusting module, humidity sensor and main circuit board adjust an in-cabinet humidity by making an inner circulation guiding airflow and an outer circulation guiding airflow to respectively flow through the humidity adjusting space. When the covering plate is removed from the shell assembly, the main circuit board is exposed outside the extra-cabinet space, in order to be directly inspected in an operating state.

### CROSS-REFERENCE TO RELATED APPLICATION

This application claims the priority benefit of Taiwan Application Serial No. 113208640, filed on Aug. 12, 2024. The entirety of the above-mentioned patent application is hereby incorporated by reference herein and made a part of the specification.

### BACKGROUND OF THE INVENTION

### Field of the Invention

The present disclosure relates to a humidity adjusting device, and more particularly, to a humidity adjusting device capable of being inspected in an operating state.

### Description of the Related Art

With the progress of technologies, there are more and more demands on the environment for storing items. Specifically, user may hope to store items in an environment with constant humidity to extend the service life of the items and maintain the quality thereof. A traditional storing method is to put items in cabinets. However, the humidity in ordinary cabinets is prone to the environment and changes accordingly, and thus cannot meet the user's demands.

To deal with the above problem, products such as the humility adjusting cabinet is developed. The humidity adjusting cabinet is a kind of storage equipment that can make use of humidity adjusting device to adjust the in-cabinet humility, to provide an ideal storage environment for items.

Specifically, the humidity adjusting cabinet can provide a relatively dry storage environment, which can prevent electronic products from being damaged by moisture. Meanwhile, the humidity adjusting cabinet can also provide a relatively humid storage environment, so as to simulate the storage condition of items under special environments in the laboratory, such as simulating whether the items will be damaged by moisture when stored on the ship.

In related art techniques, the humidity adjusting device is mostly arranged inside the storage space of the humidity adjusting cabinet. When an abnormal state occurs in the main circuit board, to inspect it requires opening the cabinet body. However, upon opening the cabinet body, the balance of the in-cabinet humidity is inevitably damaged. That is, the main circuit board cannot be inspected in an operating state, leading to inconvenience in inspecting.

In addition, in order to adjust in-cabinet humidity, a related art humidity adjusting device utilizes a shape-memorizing alloy to control swinging a valve to adjust the humidity inside the cabinet. However, this kind of control technique requires additional time to use a heater to preheat or heat the shape-memorizing alloy to make it reform, suggesting that this kind of technique cannot instantly respond to the valve, and thus leading to the difficulty in instant controls. Meanwhile, in order to retain a specific shape to maintain the state of the valve, the shape-memorizing alloy needs to be constantly heated by the heater, and thus leading to high power consumption.

### BRIEF SUMMARY OF THE INVENTION

The above fact in the related art techniques suggests that it is often necessary to open the cabinet to inspect the humidity adjusting device, and there is a common problem of inconvenient inspection. In addition, due to the characteristics of the shape-memorizing alloy, when using the shape-memorizing alloy to control the swing of the valve, there are common problems of being unable to immediately control the valve with a short response time as well as high power consumption. Therefore, the main purpose of the present disclosure is to provide a humidity adjusting device that can be inspected in the operating state, by arranging the main circuit board in the covering plate and the shell assembly to form a circuit board installation space. Therefore, when the covering plate is disassembled from the shell assembly, the main circuit board is directly exposed to the extra-cabinet space so that the inspection can be directly performed in the operating state, thereby solving the above-mentioned inconvenience in inspection.

In addition, assembling the main circuit board in the circuit board installation space can also prevent the heat generated when the main circuit board is in the operating state from affecting the temperature balance in the storage space, and can also prevent the main circuit board from being affected by vapor so that the main circuit board will not be damaged by moisture.

In addition, the present disclosure uses the motor to cooperate with the linkage assembly to drive the state-switching valve assembly, thereby immediately controlling the state-switching valve assembly switch by swinging when the motor rotates, and the supply of the power is cut after the swing is completed. As a result, the above-mentioned problems of unable to perform immediate control on the valve with a shorter response time as well as the high power consumption can be solved.

Based on the above needs, the present disclosure provides a humidity adjusting device capable of being inspected in an operating state (hereinafter referred to as “humidity adjusting device”), which is installed in a humidity adjusting cabinet with an installation opening on one of the side walls thereof. The humidity adjusting cabinet has a storage space, and the installation opening penetrates through the side wall and connects to the storage space and an extra-cabinet space of the humidity adjusting cabinet

A humidity adjusting device capable provided by the present disclosure includes a shell assembly, a covering plate, a bi-state switching valve assembly, a humidity adjusting module, a humidity sensor, and a main circuit board. The shell assembly has a humidity adjusting space and embedded at the installation opening. The shell assembly is provided with an inner circulation air inlet and an inner circulation air outlet on a side facing the storage space, and is provided with an outer circulation air inlet and an outer circulation air outlet on a side facing the extra-cabinet space. The covering plate fitly covers a side of the shell assembly adjacent to the extra-cabinet space, in order to enclosure a circuit board installation space isolated from the humidity adjusting space.

The bi-state switching valve assembly is arranged in the humidity adjusting space, and is controlled to switch by swinging in order to make the inner circulation air inlet and the inner circulation air outlet connect to the humidity adjusting space in an inner circulation operating state, and make the outer circulation air inlet and the outer circulation air outlet connect to the humidity adjusting space in an outer circulation operating state.

The humidity adjusting module is arranged in the humidity adjusting space, and is configured to generate an inner circulation guiding airflow in the inner circulation operating state, in order to make the inner circulation guiding airflow guided into the humidity adjusting space from the storage space through the inner circulation air inlet, and then flow back to the storage space through the inner circulation air outlet after an inner circulation humidity adjusting process is performed; and the humidity adjusting module is configured to generate an outer circulation guiding airflow in the outer circulation operating state, in order to make the outer circulation guiding airflow guided into the humidity adjusting space from the extra-cabinet space through the outer circulation air inlet, and then flow back to the extra-cabinet space after an outer circulation humidity adjusting process is performed.

The humidity sensor is arranged in the storage space, and configured to sense in-cabinet humidity of the storage space. The main circuit board is arranged in the circuit board installation space, and is electrically connected to the humidity sensor, the humidity adjusting module and the state-switching valve assembly, wherein the main circuit board is configured to perform switching control upon the bi-state switching valve assembly and the humidity adjusting module according to the in-cabinet humidity.

When the covering plate is removed from the shell assembly, the main circuit board is directly exposed outside the extra-cabinet space, in order to be directly inspected in the inner circulation operating state or the outer circulation operating state.

Among the ancillary technical means derived from the above necessary technical means, the housing assembly may preferably include an inner housing and an outer housing. The inner shell system is provided with an internal circulation air inlet and an internal circulation air outlet. The outer shell system is provided with an outer circulation air inlet and an outer circulation air outlet, and is fixed to the inner shell to jointly form a humidity adjustment space.

Preferably, the humidity adjusting module may include a humidity adjustment unit and an airflow guiding unit. The humidity adjustment unit is used to perform internal circulation humidity adjustment on the internal circulation guide airflow, and is used to perform outer circulation humidity adjustment on the outer circulation guide airflow. The airflow guiding unit is used to generate internal circulation guiding airflow and outer circulation guiding airflow.

Based on the above, the airflow guiding unit may be a fan, and the humidity adjustment unit can be a moisture absorber arranged to absorb to the vapor in the internal circulation guiding airflow when the internal circulation guiding airflow flows through the humidity adjustment space, and guide the moisture to outside the extra-cabinet space when the outer circulation guiding airflow flows through the humidity adjustment space.

Based on the above, the humidity adjusting module may further include a heater for heating the moisture absorber, thereby evaporating the vapor absorbed by the moisture absorber, and guiding the vapor to outside the extra-cabinet space when the outer circulation guiding airflow flows through the humidity adjustment space.

Based on the above, the humidity adjusting module may preferably further include at least one heat conducting plate. The above-mentioned heat conducting plate includes a fixed section and an extension section. The fixed section is fixed to the humidity adjustment unit. The extension section is connected to the fixed section, and bent and extended toward the outer circulation air outlet.

Preferably, the humidity adjustment device may further include a temperature sensor that is disposed in the storage space and electrically connected to the main control circuit board to sense the temperature inside a cabinet in the storage space. As mentioned above, both the temperature sensor and the humidity sensor can be electrically connected to the main control circuit board through the RS485 interface. Preferably, the humidity adjustment device may further include a status indication module, which is disposed on the main control circuit board and electrically connected to the main control circuit board to indicate an operating status or an abnormal status of the humidity adjustment device.

Among the ancillary technical means derived from the above necessary technical means, preferably, the humidity adjustment device further includes a valve driving module electrically connected to the main control circuit board, which is arranged for controlling the state switching valve assembly to switch by swing. The valve drive module includes a motor and a linkage component. The motor is arranged in the circuit board installation space, and a power output shaft protrudes into the humidity adjustment space. The linkage component is fixedly connected to the power output shaft and the state switching valve component, and is used to control the switching swing of the control state switching valve component in a linked manner when the power output shaft rotates. As mentioned above, the linkage component includes a plurality of linkage parts, and the above linkage parts are all springs.

Based on the above, the humidity adjustment device provided by this invention that can be inspected and maintained during operation is achieved by arranging the main control circuit board in the circuit board installation space enclosed by the cover plate and the housing assembly. When the cover plate is removed from the casing assembly, the main control circuit board is directly exposed to the extra-cabinet space so that it can be directly inspected during operation, thereby solving the above-mentioned inconvenient inspection problem.

In addition, assembling the main control circuit board in the circuit board installation space can also prevent the heat generated by the main control circuit board during operation from affecting the temperature balance in the storage space, and can prevent the main control circuit board from being affected by the moisture which can damage the main control circuit.

In addition, this invention uses the motor to cooperate with the linkage component to drive the state switching valve assembly, so as to immediately control the state switching valve assembly to switch by swing when the motor rotates, and stop the power supply after the swing is completed, thereby solving the above of inability to conduct timely control on the valve and the problem of power consumption.

The specific embodiments used in this invention will be further explained through the following embodiments and drawings.

### BRIEF DESCRIPTION OF THE DRAWINGS

FIG. 1 is a three-dimensional schematic diagram of a humidity adjusting device installed in a humidity adjusting cabinet that can be inspected in the operating state according to a preferred embodiment of the present disclosure.

FIG. 2 is a three-dimensional exploded schematic diagram of a humidity adjusting device installed in a humidity adjusting cabinet that can be inspected in the operating state according to a preferred embodiment of the present disclosure.

FIG. 3 is a first perspective view showing the humidity adjusting device that can be inspected in the operating state according to the preferred embodiment of the present disclosure.

FIG. 4 is a second perspective view of the humidity adjusting device that can be inspected in the operating state according to a preferred embodiment of the present disclosure.

FIG. 5 is a three-dimensional exploded schematic view of the humidity adjusting device that can be inspected in the operating state according to a preferred embodiment of the present disclosure.

FIG. 6 is a systematic block diagram showing the humidity adjusting device that can be inspected in the operating state according to a preferred embodiment of the present disclosure.

FIG. 7 is a schematic cross-sectional view showing a state-switching valve assembly of the humidity adjusting device that can be inspected in the operating state when the state-switching valve assembly is in the inner circulation operating state according to a preferred embodiment of the present disclosure.

FIG. 8 is a schematic cross-sectional view showing a state-switching valve assembly of the humidity adjusting device that can be inspected in the operating state when the state-switching valve assembly is in an outer circulation operating state according to a preferred embodiment of the present disclosure.

FIG. 9 is a schematic cross-sectional view showing a state-switching valve assembly of the humidity adjusting device that can be inspected in the operating state when the state-switching valve assembly is in an inner circulation operating state according to a preferred embodiment of the present disclosure.

FIG. 10 is a schematic three-dimensional cross-sectional view showing the state-switching valve assembly of the humidity adjusting device that can be inspected in the operating state when the state-switching valve assembly is in an outer circulation operating state according to a preferred embodiment of the present disclosure.

FIG. 11 is a three-dimensional exploded view showing that a cover of the humidity adjusting device which can be inspected in the operating state is disassembled from the shell assembly according to a preferred embodiment of the present disclosure.

### DETAILED DESCRIPTION OF THE EMBODIMENTS

Since the humidity adjusting device provided by the present disclosure can be inspected in the operating state, it can be widely used in various types of humidity adjusting cabinets, thus yielding numerous extended combinations and modifications. However, only one or few preferred embodiments are illustrated in the following detailed description.

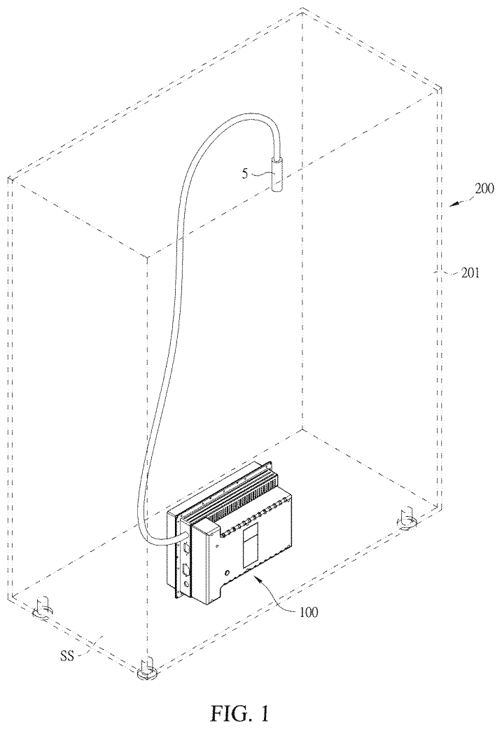

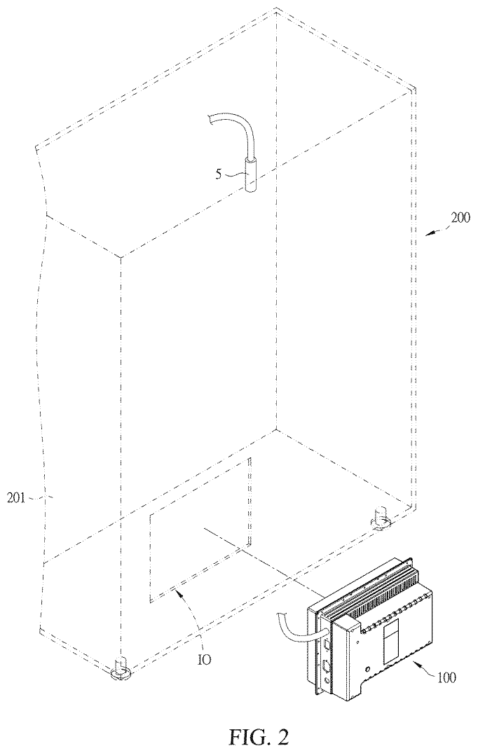

Please refer to FIG. 1 and FIG. 2. FIG. 1 is a three-dimensional schematic diagram of a humidity adjusting device installed in a humidity adjusting cabinet that can be inspected in the operating state according to a preferred embodiment of the present disclosure. FIG. 2 is a three-dimensional exploded schematic diagram of a humidity adjusting device installed in a humidity adjusting cabinet that can be inspected in the operating state according to a preferred embodiment of the present disclosure.

As shown in FIG. 1 and FIG. 2, a humidity adjusting device 100 that can be inspected in the operating state (hereinafter referred to as “humidity adjusting device”) is installed at an installation opening IO of one of the side walls 201 of a humidity adjusting cabinet 200. The humidity adjusting cabinet 200 has a storage space SS. The installation opening IO penetrates the side wall 201 and connects the storage space SS to an extra-cabinet space (not shown in the figure) of the humidity adjusting cabinet 200. The extra-cabinet space refers to the environment external to where the humidity adjusting cabinet 200 is located, which may be an ordinary indoor or outdoor environment.

In this embodiment, the humidity adjusting cabinet 200 is a dehumidification cabinet, and the humidity adjusting device 100 that needs to be operated correspondingly is a dehumidification device. In other specific applications, the humidity adjusting cabinet 200 can also be used to simulate a storage space for keeping items in a specific humid environment (such as a cabin shipping vessel). In this case, the humidity adjusting device 100 required to be correspondingly operated may be a humidification device, so as to increase the humidity inside the humidity adjusting cabinet 200.

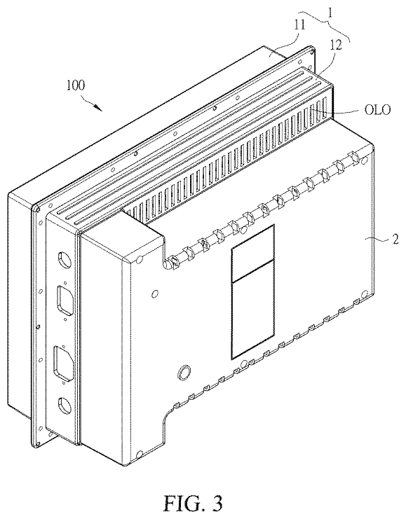

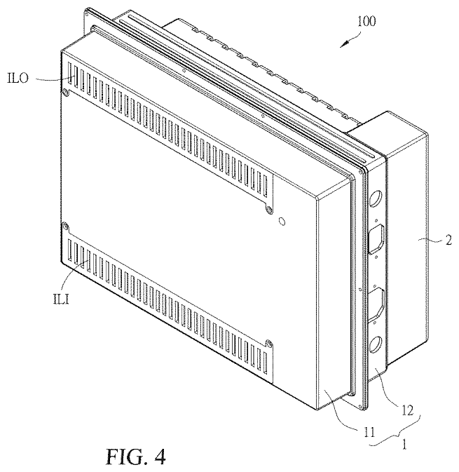

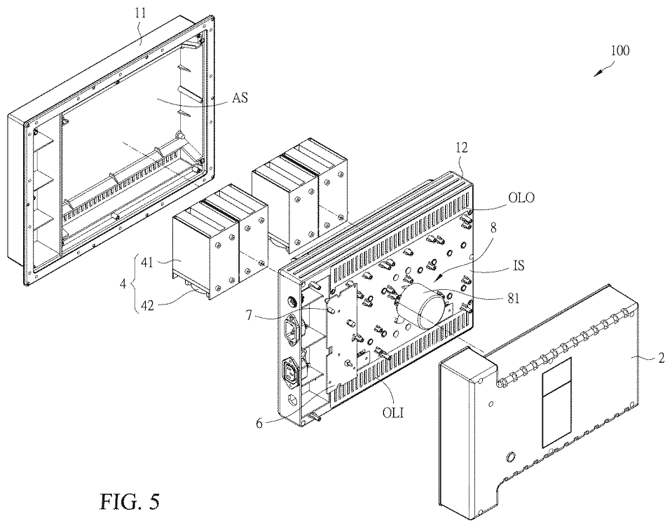

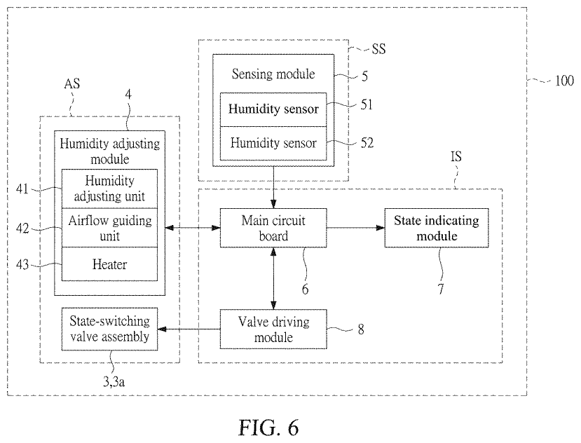

Please refer to FIG. 3 to FIG. 6. FIG. 3 is a first perspective view showing the humidity adjusting device that can be inspected in the operating state according to the preferred embodiment of the present disclosure. FIG. 4 is a second perspective view of the humidity adjusting device that can be inspected in the operating state according to a preferred embodiment of the present disclosure. FIG. 5 is a three-dimensional exploded schematic view of the humidity adjusting device that can be inspected in the operating state according to a preferred embodiment of the present disclosure. FIG. 6 is a systematic block diagram showing the humidity adjusting device that can be inspected in the operating state according to a preferred embodiment of the present disclosure. For the following contents, please refer to FIGS. 3-6 along with FIGS. 1-2.

As shown in FIGS. 3-6, the humidity adjusting device 100 includes a shell assembly 1, covering plate 2, bi-state switching valve assemblies 3 and 3a, a humidity adjusting module 4, a sensing module 5, a main circuit board 6, a state indicating module 7 and a valve driving module 8.

The shell assembly 1 has a humidity adjusting space AS, which is embedded in the installation opening IO. An inner circulation air inlet ILI and an inner circulation air outlet ILO are provided on the side of the shell assembly 1 facing the storage space SS, and an outer circulation air inlet OLI and an outer circulation air outlet OLO are provide on the side of the shell assembly 1 facing the extra-cabinet space.

In this embodiment, the shell assembly 1 comprises an inner shell 11 and an outer shell 12, and jointly form a humidity adjusting space AS. The inner shell 11 is embedded in the installation opening IO, and is provided with an inner circulation air inlet ILI and an inner circulation air outlet ILO. The outer shell 12 is provided with an outer circulation air inlet OLI and an outer circulation air outlet OLO. In other embodiments, the shell assembly 1 may be a one-piece component.

The covering plate 2 covers on one side of the shell assembly 1 adjacent to extra-cabinet space, so that the covering plate 2 and the shell assembly 1 jointly form a circuit board installation space IS isolated from the humidity adjusting space AS. In this embodiment, the covering plate 2 covers on the outer shell 12, and together with the outer shell 12, so that the covering plate 2 and the outer shell 12 jointly form a circuit board installation space IS that is isolated from the humidity adjusting space AS.

The state-switching valve assemblies 3 and 3a are arranged in the humidity adjusting space AS and can be controlled to switch by swinging, so that the inner circulation air inlet ILI and inner circulation air outlet ILO are connected to the humidity adjusting space AS in an inner circulation operating state, and the outer circulation air inlet OLI and the outer circulation air outlet OLO are connected to the humidity adjusting space AS in an outer circulation operating state.

In this embodiment, state-switching valve assembly 3 is adjacent to inner circulation air outlet ILO and the outer circulation air outlet OLO, and the state-switching valve assembly 3a is adjacent to the inner circulation air inlet ILI and the outer circulation air inlet OLI.

The humidity adjusting module 4 is arranged in the humidity adjusting space AS. When the humidity adjusting module 4 is in the inner circulation operating state, it generates an inner circulation guiding airflow, so that the inner circulation guiding airflow is introduced from the storage space SS through the inner circulation air inlet ILI to the humidity adjusting space AS. After an inner circulation humidity adjusting process is performed, the inner circulation guiding airflow flows back to the storage space SS through the inner circulation air outlet ILO.

When the humidity adjusting module 4 is in the outer circulation operating state, it generates an outer circulation guiding airflow, so that the outer circulation guiding airflow is introduced from the extra-cabinet space through the outer circulation air inlet OLI into the humidity adjusting space AS. After an outer circulation humidity adjusting process is performed, the outer circulation guiding airflow flows back to the extra-cabinet space through outer circulation air outlet OLO.

In this embodiment, the humidity adjusting module 4 comprises a humidity adjusting unit 41, an airflow guiding unit 42 and a heater 43 (marked in FIG. 6), as well as at least one heat conducting plate (this embodiments includes two heat conducting plates 44a and 44b). The humidity adjusting unit 41 is configured to perform an inner circulation humidity adjusting process on the inner circulation guiding airflow, and is configured to perform an outer circulation humidity adjusting process on the outer circulation guiding airflow.

In this embodiment, the humidity adjusting unit 41 is a moisture absorber configured to absorb the vapor (not shown) in the inner circulation guiding airflow when the inner circulation guiding airflow flows through the humidity adjusting space AS, and to guide the vapor into the extra-cabinet space when the outer circulation guiding airflow flows through the humidity adjusting space AS. In other embodiments, the humidity adjusting unit 41 may be a humidifier configured to absorb the vapor in the outer circulation guiding airflow when the outer circulation guiding airflow flows through humidity adjusting space AS, and to guide the vapor into the storage space SS when the inner circulation guiding airflow flows through the humidity adjusting space AS

The airflow guiding unit 42 is configured to generate an inner circulation guiding airflow and an inner circulation guiding airflow. In this embodiment, the airflow guiding unit is a fan. The heater 43 is configured to heat the moisture absorber in order to absorb the evaporated vapor, and guide the evaporated vapor into the extra-cabinet space when the outer circulation guiding airflow flows through the humidity adjusting space AS.

In this embodiment, the heater 43 is a mica heating plate. In other embodiments, the heater 43 can be other types of heating units. In this embodiment, there is a plurality of humidity adjusting modules 4, that is, there is a plurality of humidity adjusting units, a plurality of airflow guiding units and a plurality of heaters. In other embodiments, there may be only one humidity adjusting module 4.

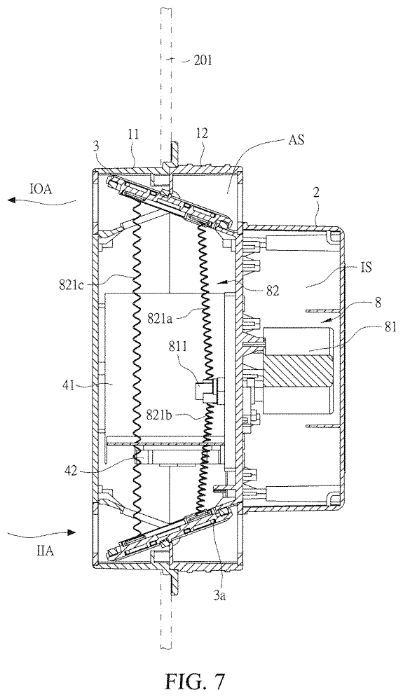

The heat conducting plate 44a includes a fixed section 441a (marked in FIG. 7) and an extension section 442a. The fixed section 441a is fixed to the humidity adjustment unit 41 (by locking, welding, etc.). The extension section 442a is connected to the fixed section 441a, and is bent and extends toward the outer circulation air outlet OLO. After the heater 43 heats the humidity adjustment unit 41, the heat can be transferred to the end of the extension section 442a via the fixed section 441a, thereby fully heating the external circulation guide airflow to increase the dehumidification efficiency. In this embodiment, a groove is provided in the extension section 442a to form two protruding arms, so that heat can be concentrated on the two protruding arms.

In addition, since the extension section 442a has a curved surface, so as to more efficiently direct the external circulation guiding airflow to the external circulation air outlet OLO to increase the flow efficiency. As the structure and working principle of the heat conduction plate 44b are the same as those of the heat conduction plate 44a, the details thereof can be referred to the corresponding paragraphs and will not be further described here for brevity.

The sensing module 5 includes a humidity sensor 51 (marked in FIG. 6) and a temperature sensor 52 (marked in FIG. 6). The humidity sensor 51 is arranged in the storage space SS and configured to sense in-cabinet humidity in one of the storage space SS. The temperature sensor 52 is arranged in the storage space SS and configured to sense the in-cabinet temperature in the storage space SS.

The main circuit board 6 is arranged in a circuit board installation space IS, and electrically connected to the sensing module 5 (which comprises the humidity sensor 51 and temperature sensor 52), humidity adjusting module 4 and state-switching valve assemblies 3 and 3a. The main circuit board 6 is configured to control the state-switching valve assemblies 3 and 3a and humidity adjusting module 4 according to switching of the in-cabinet humidity.

In this embodiment, the humidity sensor 51 and the temperature sensor 52 are both electrically connected to the main circuit board 6 through the RS485 interface. In other embodiments, the RS485 interface can be replaced with another type of communication interface.

The state indicating module 7 is arranged in the main circuit board and electrically connected to the main circuit board, and is configured to indicate an operating state or an abnormal state of the humidity adjusting device 100. In this embodiment, the state indicating module 7 may be a light-emitting diode (LED) configured to show an operating state or an abnormal state of the humidity adjusting device 100. In this embodiment, the covering plate 2 has a status display hole (not shown) for exposing the state indicating module 7 when the covering plate 2 covers the shell assembly 1.

For example, the green light may be used to indicate that the humidity adjusting device 100 is in the inner circulation operating state, and different flashing frequencies may be used to indicate the change of the state. The blue light may be used to indicate that the humidity adjusting device 100 is in the outer circulation operating state, and different flashing frequencies may be used to indicate the change of the state.

In addition, the red light may be used to indicate that the humidity adjusting device 100 is in the abnormal state, and different abnormal states can be indicated by different flashing frequencies for a maintenance personnel's reference when inspecting. In this embodiment, in order to display different abnormal states, the humidity adjusting device 100 further includes a micro-switch sensor, a current sensor, an over-voltage detector, a vibration sensor and an over-protection sensor (not shown), which are all electrically connected to a main circuit board.

The micro-switch sensor is configured to determine whether any of the state-switching valve assemblies 3 and 3a is abnormal. The current sensor and overvoltage detector are configured to determine whether the power input to the humidity adjusting device 100 is abnormal. The over-temperature protection sensor is configured to determine whether the heater 43 is abnormal. In addition, the temperature sensor 52 can also be used to determine whether the in-cabinet temperature is abnormal.

In other embodiments, the state indicating module 7 can be a buzzer, which emits different alarming sounds when the humidity adjusting device 100 is in different abnormal states.

The valve driving module 8 is electrically connected to a main circuit board 6 to control the state-switching valve assemblies 3 and 3a to switch by swinging. In this embodiment, the valve driving module 8 comprises a motor 81 and a linkage assembly 82 (marked in FIG. 7). The motor 81 is arranged in the circuit board installation space IS, and a power-output shaft 811 protrudes toward the humidity adjusting space AS. The linkage assembly 82 is fixedly connected to the motor 81 and the state-switching valve assemblies 3 and 3a, and is configured to control the state-switching valve assemblies 3 and 3a to correspondingly switch by swinging when the power-output shaft 811 rotates.

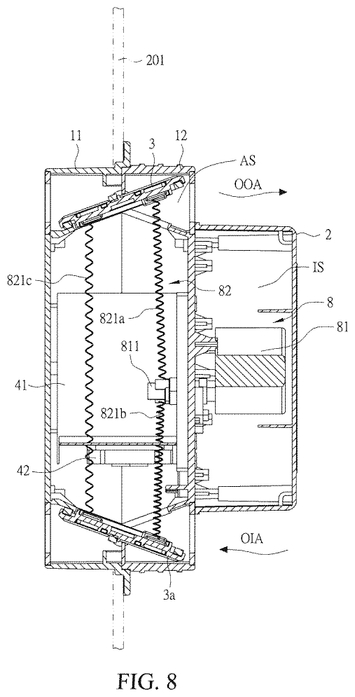

Please refer to FIGS. 7 and 8. FIG. 7 is a schematic cross-sectional view showing a state-switching valve assembly of the humidity adjusting device that can be inspected in the operating state when the state-switching valve assembly is in the inner circulation operating state according to a preferred embodiment of the present disclosure. FIG. 8 is a schematic cross-sectional view showing a state-switching valve assembly of the humidity adjusting device that can be inspected in the operating state when the state-switching valve assembly is in an outer circulation operating state according to a preferred embodiment of the present disclosure.

As shown in FIG. 7, when the humidity adjusting device 100 is in the inner circulation operating state, the state-switching valve assemblies 3 and 3a are controlled to swing, so that the inner circulation air inlet ILI and the inner circulation air outlet ILO are connected to the humidity adjusting space AS. In this moment, the airflow guiding unit 42 generates the inner circulation guiding airflow.

The inner circulation guiding airflow comprises inner circulation inlet airflow IIA and inner circulation outlet airflow IOA. The inner circulation inlet airflow IIA is introduced into the humidity adjusting space AS through the inner circulation air inlet ILI, and the inner circulation outlet airflow IOA flows back to the storage space SS through the inner circulation air outlet ILO. In this embodiment, the humidity adjusting unit 41 is a moisture absorber. Therefore, during the inner circulation humidity adjusting process, the vapor in the storage space SS is absorbed by the moisture absorber to reduce the in-cabinet humidity.

The moisture absorption capability of the moisture absorber may decrease with the amount of vapor absorbed. In other words, the more vapor absorbed, the worse the moisture absorption capability of the moisture absorber. Therefore, there is a need for an outer circulation humidity adjusting process after the inner circulation humidity adjusting process.

As shown in FIG. 8, when the humidity adjusting device 100 is in the outer circulation operating state, the state-switching valve assemblies 3 and 3a are controlled to swing, so that the outer circulation air inlet and the outer circulation air outlet are connected to the humidity adjusting space AS. In this moment, the airflow guiding unit 42 generates the outer circulation guiding airflow, and also enables the heater 43. The outer circulation guiding airflow comprises the outer circulation guiding airflow OIA and the outer circulation guiding airflow OOA.

The outer circulation guiding airflow OIA is introduced into the humidity adjusting space AS through the outer circulation air inlet OLI. The outer circulation guiding airflow OOA flows back to the extra-cabinet space through the outer circulation air outlet OLO. In this embodiment, during the outer circulation humidity adjusting process, the heater 43 evaporates the vapor absorbed by the moisture absorber, and guides the evaporated vapor into the extra-cabinet space when the outer circulation guiding airflow flows through humidity adjusting space AS, thus restoring the moisture absorbing ability of the moisture absorber.

In this embodiment, the switching between different operating states is determined by the main circuit board 6. The main circuit board 6 uses the humidity sensor 51 to sense the in-cabinet humidity in the storage space SS. When the in-cabinet humidity is too high, the state-switching valve assemblies 3 and 3a are controlled to switch to the inner circulation operating state. When the moisture absorption capability of the moisture absorber decreases, the state-switching valve assemblies 3 and 3a are controlled to switch to the outer circulation operating state, and the heater 43 is also enabled. As there are known techniques regarding how to control the humidity which are not the main focus of the present disclosure, the detailed description thereof is omitted in this embodiment for brevity.

In the embodiment, the humidity adjusting device 100 may be a humidification device. The humidity adjusting module 4 further comprises a condenser, configured to condense vapor when the outer circulation guiding airflow flows through the humidity adjusting space AS, so that the humidity adjusting unit 41 absorbs the vapor, and guides the absorbed vapor into the storage space SS when the inner circulation guiding airflow flows through the humidity adjusting space AS so as to increase the in-cabinet humidity. That is, the humidity adjusting device 100 adjusts the in-cabinet humidity through the inner circulation humidity adjusting process, and then restores the humidity adjusting ability of the humidity adjusting unit 41 through the outer circulation humidity adjusting process.

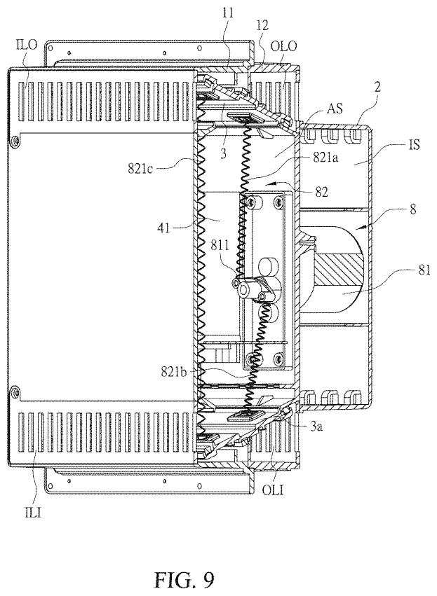

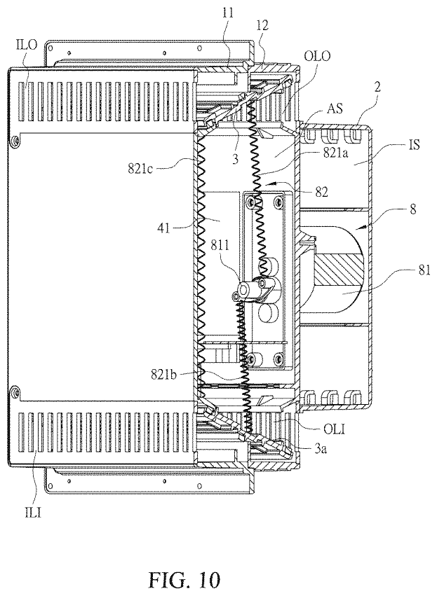

Please refer to FIGS. 9 and 10. FIG. 9 is a schematic cross-sectional view showing a state-switching valve assembly of the humidity adjusting device that can be inspected in the operating state when the state-switching valve assembly is in an inner circulation operating state according to a preferred embodiment of the present disclosure.

FIG. 10 is a schematic three-dimensional cross-sectional view showing the state-switching valve assembly of the humidity adjusting device that can be inspected in the operating state when the state-switching valve assembly is in an outer circulation operating state according to a preferred embodiment of the present disclosure. In this embodiment, linkage assembly 82 comprises three linkages 821a to 821c. The both ends of the linkage 821a are fixedly connected to the state-switching valve assembly 3 and the power-output shaft 811 respectively. The both ends of the linkage 821b are fixedly connected to the state-switching valve assembly 3a and the power-output shaft 811 respectively. The both ends of the linkage 821c are fixedly connected to state-switching valve assemblies 3 and 3a at both ends respectively. In this embodiment, the linkages 821a to 821c may all be springs. As shown in FIG. 9, in the inner circulation operating state, since the sum of the restoring forces of the linkage 821a and 821b is greater than the restoring force of linkage 821c, the state-switching valve assemblies 3 and 3a are pulled by the linkage 821a and 821b at this time, causing the inner circulation air inlet ILI and the inner circulation air outlet ILO remain connected to the humidity adjusting space AS.

As shown in FIG. 10, when it is there is a need for switching to the outer circulation operating state, the motor 81 drives the power-output shaft 811 to rotate so that the restoring force of the linkage 821c is greater than the sum of the restoring forces of the linkage 821a and 821b, so that the state-switching valve assemblies 3 and 3a are pulled by the linkage 821c, in order to make the outer circulation air inlet OLI and the outer circulation air outlet OLO remain connected to the humidity adjusting space AS.

In prior art techniques, the state-switching valve assemblies 3 and 3a are driven by a memory shaping alloy. The memory shaping alloy is a composite material with different deformations at different temperatures. Specifically, it is in one shape when heated to a high temperature, and deforms to another shape after cooling. Therefore, with heating and cooling the memory shaping alloy, the state-switching valve assemblies 3 and 3a can be controlled to switch by swinging at different temperatures.

However, since memory shaping alloys require a certain period of time for heating or cooling to deform, there is a common problem of slow response. In addition, to keep the memory shaping alloy in a shape corresponding to a high temperature (that is, maintain the memory shaping alloy in the inner circulation operating state or the outer circulation operating state), there is a common problem of high power consumption due to constantly heating.

In other words, compared to the memory shaping alloy, the motor 81 can use the linkage assembly 82 to instantly switch the state-switching valve assemblies 3 and 3a by swinging when the power-output shaft 811 rotates. There is no need to continue power supply after switching to the inner circulation operating state or the outer circulation operating state.

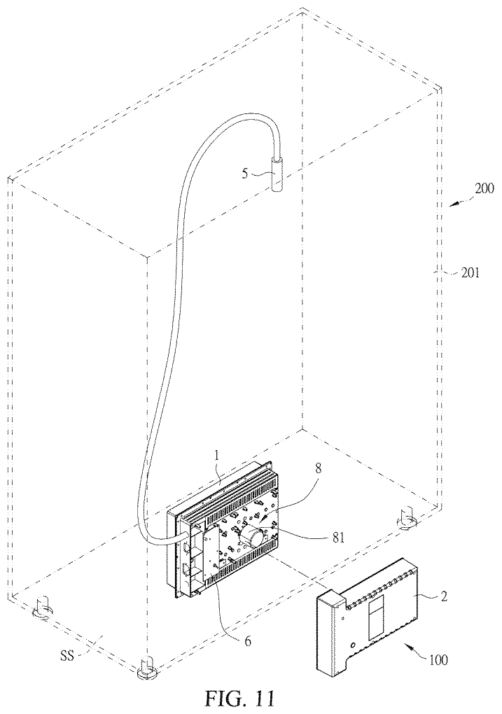

Please continue to refer to FIG. 11. FIG. 11 is a three-dimensional exploded view showing that a cover of the humidity adjusting device which can be inspected in the operating state is disassembled from the shell assembly according to a preferred embodiment of the present disclosure. As shown in FIG. 11, when the maintenance personnel observes through the status display hole that the state indicating module 7 shows that the humidity adjusting device 100 is in an abnormal state (such as flashing red light), the maintenance personnel can disassemble the covering plate 2 from the shell assembly 1, and directly perform maintenance on the main circuit board 6 without affecting the operating state of the humidity adjusting device 100, so that the balance of the temperature and humidity in the storage space SS can be maintained.

Based on the above, in the humidity adjusting device 100 provided by the present disclosure, the main circuit board 6 is arranged at a circuit board installation space IS formed by the covering plate 2 and shell assembly 1, so that when the covering plate 2 can be self-shelled is dissembled from the shell assembly 1, the main circuit board 6 is directly exposed to the extra-cabinet space so that it can be directly inspected in the operating state (which comprises the inner circulation operating state and the outer circulation operating state), thereby solving the above problems.

In addition, installing the main circuit board 6 in the circuit board installation space IS can also prevent the heat generated by the main circuit board 6 in the operating state from affecting the temperature balance of the storage space SS, and prevent the main circuit board 6 from the moisture damage caused by vapor. In addition, the present disclosure uses the motor 81 to cooperate with the linkage assembly 82 to drive the state-switching valve assemblies 3 and 3a, thereby immediately controlling the state-switching valve assembly 3 and 3 a to switch by swinging when the motor 81 rotates, and stopping the power supply after the swinging is completed, thus solving the above-mentioned problems of being unable to control the valve immediately with a short response time as well as the high power consumption.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A humidity adjusting device capable of being inspected in an operating state, being installed at an installation opening provided on a side wall of a humidity adjusting cabinet; the humidity adjusting cabinet having a storage space, and the installation opening penetrating the side wall and connecting to the storage space and an extra-cabinet space of the humidity adjusting cabinet; the humidity adjusting device comprising:
a shell assembly having a humidity adjusting space and embedded at the installation opening, wherein the shell assembly is provided with an inner circulation air inlet and an inner circulation air outlet on a side facing the storage space, and is provided with an outer circulation air inlet and an outer circulation air outlet on a side facing the extra-cabinet space;
a covering plate fitly covering a side of the shell assembly adjacent to the extra-cabinet space, in order to enclosure a circuit board installation space isolated from the humidity adjusting space;
a bi-state switching valve assembly arranged in the humidity adjusting space, and being controlled to switch by swinging in order to make the inner circulation air inlet and the inner circulation air outlet connect to the humidity adjusting space in an inner circulation operating state, and make the outer circulation air inlet and the outer circulation air outlet connect to the humidity adjusting space in an outer circulation operating state;
a humidity adjusting module arranged in the humidity adjusting space, and configured to generate an inner circulation guiding airflow in the inner circulation operating state, in order to make the inner circulation guiding airflow guided into the humidity adjusting space from the storage space through the inner circulation air inlet, and then flow back to the storage space through the inner circulation air outlet after an inner circulation humidity adjusting process is performed; and the humidity adjusting module is configured to generate an outer circulation guiding airflow in the outer circulation operating state, in order to make the outer circulation guiding airflow guided into the humidity adjusting space from the extra-cabinet space through the outer circulation air inlet, and then flow back to the extra-cabinet space after an outer circulation humidity adjusting process is performed;
a humidity sensor arranged in the storage space, and configured to sense in-cabinet humidity of the storage space; and
a main circuit board arranged in the circuit board installation space, and electrically connected to the humidity sensor, the humidity adjusting module and the state-switching valve assembly, wherein the main circuit board is configured to perform switching control upon the bi-state switching valve assembly and the humidity adjusting module according to the in-cabinet humidity;
wherein when the covering plate is removed from the shell assembly, the main circuit board is directly exposed outside the extra-cabinet space, in order to be directly inspected in the inner circulation operating state or the outer circulation operating state.

2. The humidity adjusting device capable of being inspected in the operating state according to claim 1, wherein the shell assembly comprises:
an inner shell provided with the inner circulation air inlet and the inner circulation air outlet; and
an outer shell provided with the outer circulation air inlet and the outer circulation air outlet, and is fixedly connected to the inner shell, in order to jointly enclosure the humidity adjusting space.

3. The humidity adjusting device capable of being inspected in the operating state according to claim 1, wherein the humidity adjusting module comprises:
a humidity adjusting unit configured to perform the inner circulation humidity adjusting process to the inner circulation guiding airflow, and configured to perform the outer circulation humidity adjusting process to the outer circulation guiding airflow; and
an airflow guiding unit configured to generate the inner circulation guiding airflow and the outer circulation guiding airflow.

4. The humidity adjusting device capable of being inspected in the operating state according to claim 3, wherein the airflow guiding unit is a fan, and the humidity adjusting unit is a moisture absorber configured to absorb vapor inside the inner circulation guiding airflow when the inner circulation guiding airflow flows through the humidity adjusting space, and guide the vapor into the extra-cabinet space when the outer circulation guiding airflow flows through the humidity adjusting space.

5. The humidity adjusting device capable of being inspected in the operating state according to claim 4, wherein the humidity adjusting module further comprises a heater, and the heater is configured to heat the moisture absorber, in order to evaporate the vapor absorbed by the moisture absorber, and carry the evaporated vapor into the extra-cabinet space when the outer circulation guiding airflow flows through the humidity adjusting space.

6. The humidity adjusting device capable of being inspected in the operating state according to claim 5, wherein the humidity adjusting module further comprises at least one heat conducting plate, and the heat conducting plate comprises:
a fixed section fixed to the humidity adjusting unit; and
an extension section connected to the fixed section, and being bent and extended toward the outer circulation air outlet.

7. The humidity adjusting device capable of being inspected in the operating state according to claim 1, further comprising a temperature sensor, wherein the temperature sensor is arranged in the storage space, and electrically connected to the main circuit board, in order to sense an in-cabinet temperature of the storage space.

8. The humidity adjusting device capable of being inspected in the operating state according to claim 7, wherein both the temperature sensor and the humidity sensor are electrically connected to the main circuit board through a RS485 interface.

9. The humidity adjusting device capable of being inspected in the operating state according to claim 1, further comprising a state indicating module, wherein the state indicating module is arranged in the main circuit board, and electrically connected to the main circuit board to indicate operating state or an abnormal state of the humidity adjusting device.

10. The humidity adjusting device capable of being inspected in the operating state according to claim 1, further comprising a valve driving module, the valve driving module is electrically connected to the main circuit board, and configured to control the bi-state switching valve assembly to switch by swinging; the valve driving module comprising:
a motor arranged in the circuit board installation space, and protruding inward to the humidity adjusting space with a power-output shaft; and
a linkage assembly fixedly connected to the power-output shaft and the bi-state switching valve assembly, and configured to synchronously control the bi-state switching valve assembly to switch by swinging when the power-output shaft rotates.

11. The humidity adjusting device capable of being inspected in the operating state according to claim 10, wherein the linkage assembly comprises a plurality of linkages, and all the linkages are springs.
